(19) United States
(12) Patent Application Publication
(10) Pub. No.: US 2006/0262493 A1
(43) Pub. Date: Nov. 23, 2006

(54) Method of inputting data in wireless terminal using jog key and a wireless terminal implementing the same

(75) Inventor: Young-Hoon Jung, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/353,197

(22) Filed: Feb. 14, 2006

(30) Foreign Application Priority Data
May 18, 2005 (KR) 2005-41506

(51) Int. Cl. G06F 1/16

(52) U.S. Cl. 361/680; 361/683; 345/169

(57) ABSTRACT

A method of inputting data and a wireless terminal comprising a jog key are provided. Whether a current mode is a jog key using mode is determined. If the current mode is the jog key using mode, the following operations are performed: displaying a data display window, determining a position of a reference point of the jog key and displaying data corresponding to the position of the reference point in the data display window, and inputting the data displayed in the data display window.

### PRIORITY

This application claims the benefit under 35 U.S.C. § 119(a) of a Korean paten application, entitled “Method of Inputting Data in Wireless Terminal”, filed in the Korean Intellectual Property Office on May 18, 2005 and assigned Serial No. 2005-41506, the entire contents of which are hereby incorporated by reference.

### BACKGROUND OF THE INVENTION

1. Field of the Invention

The present invention relates to a method of inputting data in a wireless terminal. In particular, the present invention relates to a method of inputting data by using a jog key and wireless terminal implementing the same.

2. Description of the Related Art

In general, wireless terminals (various kinds of wireless communication devices, such as portable phones, cellular phones, personal digital assistances (PDAs)) have been put on the market for users to use without concerning with a telephone line. The wireless terminals have been rapidly developed, thereby recently providing various services, such as a conventional voice call service, a data service, and an Internet service, to the users. According to the development in wireless communication technologies, many functions to provide the services have been installed in the wireless terminals.

Such a wireless terminal may be portable. That is, because it is inconvenient if the wireless terminal is too big or heavy to carry, developments to reduce the size and weight of the wireless terminal have been continuously proceeded. However, the wireless terminal may comprise basic keys. That is, the wireless terminal may comprise numeral keys for dialing, a ‘*’ key and a ‘#’ key used for specific functions, and function keys used for executing various functions. Since the keys included in the wireless terminal are used by being pressed by a user, a problem may occur if the size of the keys is miniaturized below an appropriate size because it is difficult for the user to press a key having a too small size. To solve this problem, various methods are considered for the wireless terminal, an example of which is a method of using a jog key. The jog key is a kind of pointing device driver for easily moving a direction of a cursor here and there, and when the jog key is used with a keypad, the jog key may play a significant role in some cases. For example, a multi-function of the wireless terminal is selected by moving the jog key in a left/right direction, and data corresponding to the selected function is input by using the keypad.

However, a conventional jog key is used only for selecting a function and cannot be used for inputting data. Thus, when a folder is folded and a keypad is not seen, data cannot be input.

### SUMMARY OF THE INVENTION

An object of the present invention is to address at least the above problems and/or disadvantages and to provide at least the advantages below. Accordingly, an object of the present invention is to provide a method of inputting data by using a jog key, and a wireless terminal utilizing the same.

According to one aspect of the present invention, a method of inputting data, and a wireless terminal comprising a jog key for implementing the method are provided. Whether a current mode is a jog key using mode is determined. If the current mode is the jog key using mode, a data display window is displayed. A position of a reference point of the jog key is determined, data corresponding to the position of the reference point is displayed in the data display window, and the data displayed in the data display window is input.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a wireless terminal according to an exemplary embodiment of the present invention;

FIGS. 2A and 2B are flowcharts illustrating a method of inputting data by using a jog key, according to an exemplary embodiment of the present invention;

FIGS. 3A and 3B are flowcharts illustrating a method of inputting data by using the jog key in a calculator mode, according to an exemplary embodiment of the present invention;

FIGS. 4A and 4B are flowcharts illustrating a method of inputting data by using the jog key in a music file reproduction mode according to an exemplary embodiment of the present invention;

FIGS. 5A through 5D are views illustrating the data input with respect to the method of FIGS. 2A and 2B according to an exemplary embodiment of the present invention;

FIGS. 6A through 6D are views illustrating the data input with respect to the method of FIGS. 3A and 3B according to an exemplary embodiment of the present invention; and

FIGS. 7A through 7D are views illustrating the data input with respect to the method of FIGS. 4A and 4B according to an exemplary embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will be described herein below with reference to the accompanying drawings. In the following description, well-known functions or constructions will be omitted for clarity and conciseness.

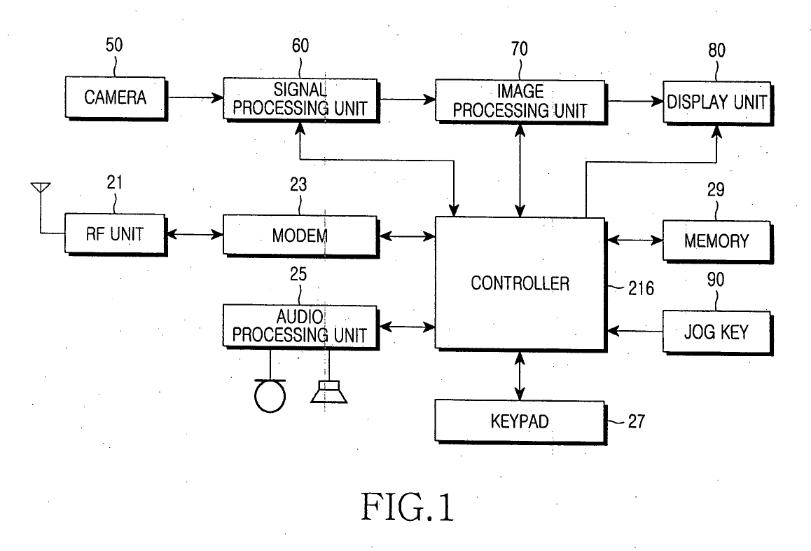

FIG. 1 is a block diagram illustrating a wireless terminal according to an exemplary embodiment of the present invention. Referring to FIG. 1, a radio frequency (RF) unit 21 performs communication of the wireless terminal. The RF unit 21 comprises a RF transmitter for up-converting a frequency of a signal to be transmitted and amplifying the up-converted signal, and a RF receiver for low noise amplifying a received signal and down-converting a frequency of the low noise amplified signal.

A modem 23 comprises a transmitter for encoding and modulating the signal to be transmitted and a receiver for demodulating and decoding the received signal.

An audio processing unit 25 may comprise a codec, which includes a data codec for processing packet data and an audio codec for processing an audio signal. The audio processing unit 25 converts a digital audio signal received from the modem 23 to an analog audio signal by using the audio codec and reproduces the converted analog audio signal, or converts an analog audio signal generated by a microphone to a digital audio signal by using the audio codec and transmits the converted digital audio signal to the modem 23. The codec can separately exist or be included in a controller 216.

A keypad 27 comprises keys for inputting numeral and character information and function keys for establishing various functions.

A memory 29 may comprise a program memory and a data memory. The program memory stores programs for controlling a general operation of the wireless terminal, a jog key control program according to an exemplary embodiment of the present invention, a program for displaying a data display window in a jog key using mode, a calculator program, and a music file reproduction program. The data memory temporarily stores data generated during the execution of the programs, and stores a plurality of music files according to an exemplary embodiment of the present invention.

A jog key 90 may comprise a motion signal generator for generating a motion signal of a reference point and a selection signal generator for generating a selection signal. The motion signal generator of the jog key 90 outputs a jog key reference point position signal generated by rotating the jog key 90 in a left or right direction to the controller 216. The jog key 90 also may comprise alternating N poles and S poles, wherein a pair of N pole and S pole is established as a single unit, and data can be matched with each unit. For example, if 36 pairs of N poles and S poles comprise around 360°, 36 units exist, and therefore, if the reference point of the jog key 90 moves by 10°, the reference point moves by a single unit, thereby outputting a data signal matching the one-unit movement, and if the reference point of the jog key 90 moves by 20°, the reference point moves by two units, thereby outputting a data signal for matching the two-unit movement. The selection signal generator generates a signal for requesting for the selection of data and outputs the generated signal to the controller 216.

The controller 216 controls a general operation of the wireless terminal. The controller 216 may comprise the modem 23 and the codec. According to an exemplary embodiment of the present invention, the controller 216 determines whether a current mode is a jog key using mode, controls a display unit 80 to display a data display window if the current mode is the jog key using mode, determines a position of the jog key reference point and controls the display unit 80 to display data corresponding to the position in the data display window, and inputs the data displayed in the data display window if the selection signal is detected. In addition, according to an exemplary embodiment of the present invention, when a calculator mode key is pressed, the controller 216 establishes jog key directions in the calculator mode and data corresponding to the jog key directions, determines a position of the jog key reference point and controls the display unit 80 to display data corresponding to the position in the data display window. In addition, according to an exemplary embodiment of the present invention, when a music file reproduction key is pressed, the controller 216 establishes jog key directions in the music file reproduction mode and data corresponding to the jog key directions, determines a position of the jog key reference point and controls the display unit 80 to display data corresponding to the position in the data display window.

A camera 50 photographs an image and comprises a camera sensor for converting an optical signal obtained through the photographing to an electrical signal. It is assumed that the camera sensor is a charge coupled device (CCD) sensor. The camera 50 performs a function of photographing an image of document according to an exemplary embodiment of the present invention.

A signal processing unit 60 converts the electrical signal output from the camera 50 to an image signal. The signal processing unit 60 can be implemented by using a digital signal processor (DSP).

An image processing unit 70 generates image data for displaying the image signal output from the signal processing unit 60. The controller 216 controls the image processing unit 70 to generate the image data suitable for the specification of the display unit 80 by using the input image signal and outputs the generated image data to the display unit 80. The image processing unit 70 compresses and expands the image data. In addition, the controller 216 controls the image processing unit 70 to transmit a start address value of the output image data to the display unit 80, or change the start address value and transmits the changed start address value to the display unit 80.

The display unit 80 displays the image data output from the image processing unit 70. A liquid crystal display (LCD) can be used for the display unit 80. In this case, the display unit 80 can comprise a LCD controller, a memory for storing image data, and a LCD display element. When the LCD is implemented in a touch screen method, the keypad 27 and the LCD can be an input unit. The display unit 80 comprises an image data display unit on which image data is displayed.

An operation of the wireless terminal will now be described with reference to FIG. 1. When a user wants to make a phone call, if the user sets an outgoing mode after performing a dialing operation by using the keypad 27, the controller 216 detects the outgoing mode, controls the modem 23 to process the received dial information, and controls the RF unit 21 to convert the dial signal to a RF signal and transmit the RF signal through an antenna. If a response signal is generated in the other side, the controller 216 detects the response signal. Thereafter, the controller 216 performs a communication function by forming a voice call path by using the audio processing unit 25. In an incoming mode, the controller 216 detects signals by using the modem 23 that the wireless terminal is in the incoming mode and generates a ring signal by using the audio processing unit 25. When the user responds to the incoming call, the controller 216 detects the response and performs the communication function by forming a voice call path by using the audio processing unit 25. In the outgoing mode and the incoming mode, the voice communication has been described as an example, however, a data communication function to transmit/receive packet data and image data may be performed besides the voice communication. When a short message service is performed in an idle mode, the controller 216 displays character data processed by the modem 23 on the display unit 80.

An operation of inputting data by using the jog key 90 in the wireless terminal according to an exemplary embodiment of the present invention will now be described. The controller 216 determines whether a current mode is the jog key using mode, and if the current mode is the jog key using mode, the controller 216 controls the memory 29 and the display unit 80 to display the data display window. If the user moves the jog key 90 left or right, the motion signal generator of the jog key 90 outputs a position signal of the jog key reference point to the controller 216. The controller 216 determines a position of the jog key reference point and detects a data signal of a numeral, a specific character, or a symbol corresponding to the position. Then, the controller 216 controls the memory 29 and the display unit 80 to display the data in the data display window, and if a selection signal is detected, the controller 216 inputs the data displayed in the data display window.

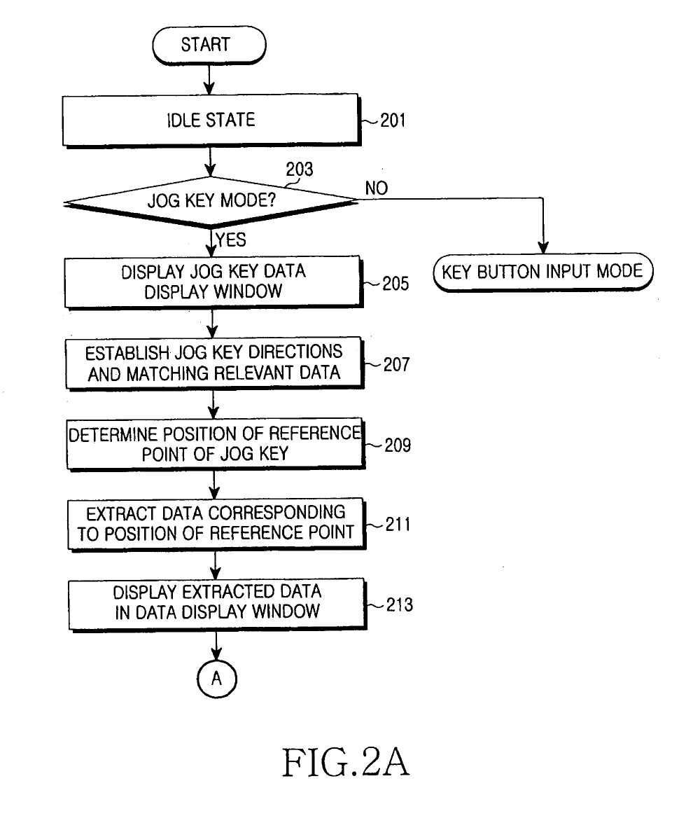

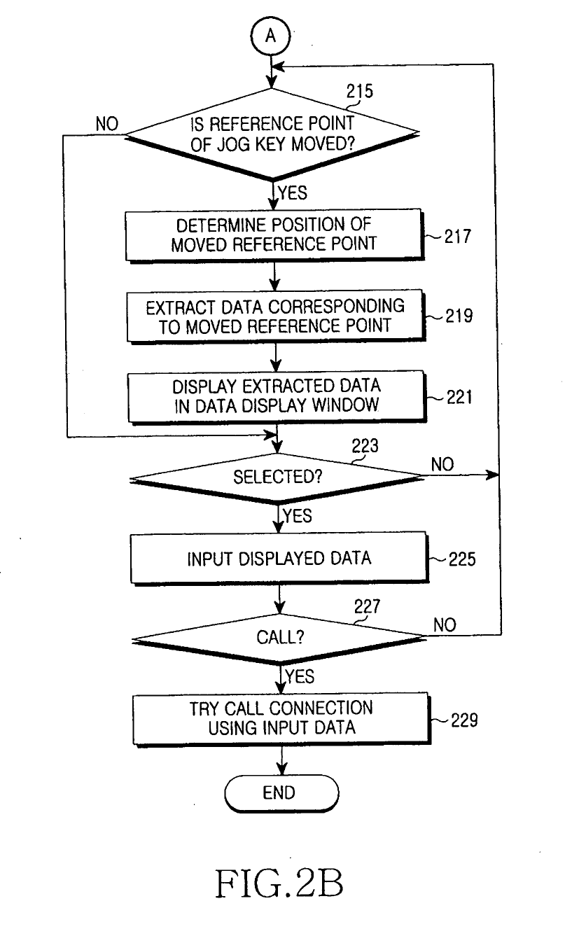

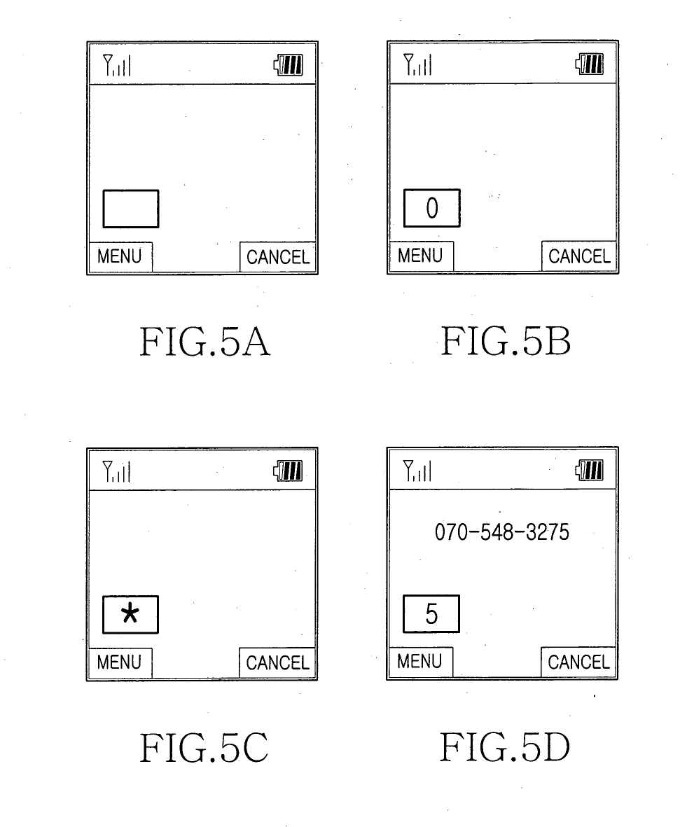

FIGS. 2A and 2B are flowcharts illustrating a method of inputting data by using the jog key 90, according to an exemplary embodiment of the present invention, and FIGS. 5A through 5D are views illustrating the data input with respect to the method of FIGS. 2A and 2B according to an exemplary embodiment of the present invention. An operation of inputting data by using the jog key 90 to make a phone call will now be described with reference to FIGS. 2A and 2B and FIGS. 5A through 5D. In an idle mode of step 201, the controller 216 determines in step 203 whether a current mode of the wireless terminal is the jog key using mode. If the current mode is the jog key using mode as the determination result, in step 205, the controller 216 controls the memory 29 and the display unit 80 to display the data display window (jog key data display window) as illustrated in FIG. 5A. Even if a folder is folded and the keypad 27 is not seen, the jog key using mode can be activated by using a side key, such as hot key.

In step 207, the controller 216 determines a current mode of the wireless terminal and establishes jog key directions by controlling the memory 29 and the jog key 90. For example, if the current mode is a phone call mode, which is the default mode, a plurality of pairs of N poles and S poles are divided into 12 directions matching ‘0-9,’ ‘*,’ and ‘#,’ which are data required in the phone call mode.

In step 209, the controller 216 determines a position of the reference point of the jog key 90 by controlling the memory 29 and the jog key 90. In step 211, the controller 216 extracts data corresponding to the position of the reference point. In step 213, the controller 216 controls the display unit 80 to display the extracted data in the data display window as illustrated in FIG. 5B. For example, when ‘0-9, *, and #’ match ‘first direction-twelfth direction’ established to the jog key 90, respectively, if the reference point of the jog key 90 is located at the first direction, ‘0’ is displayed in the data display window, and if the reference point of the jog key 90 is located at the twelfth direction, ‘#’ is displayed in the data display window.

When the user moves the reference point of the jog key 90 in the left or right direction to input desired data, the jog key 90 outputs a jog key reference point position signal generated by the left or right rotation to the controller 216. In step 215, the controller 216 determines whether the jog key reference point position signal is input. If the jog key reference point position signal is input, the controller 216 determines a position of the moved reference point in step 217, extracts data corresponding to the position of the reference point in step 219, and controls the display unit 80 to display the extracted data in the data display window as illustrated in FIG. 5C in step 221.

In step 223, the controller 216 determines whether the user presses a ‘selection’ key to input the data displayed in the data display window. If the ‘selection’ key is pressed, in step 225, the controller 216 inputs the data displayed in the data display window by controlling the memory 29 and the display unit 80 and displays the input data as illustrated in FIG. 5D. The data input can be achieved by pressing the jog key 90 or using the side key.

In step 227, the controller determines whether a ‘call’ key is pressed. If the ‘call’ key is pressed, in step 229, the controller 216 tries a call connection using the input data by controlling the RF unit 21. The ‘call’ key can be replaced by pressing the jog key 90 for a long time or using the side key.

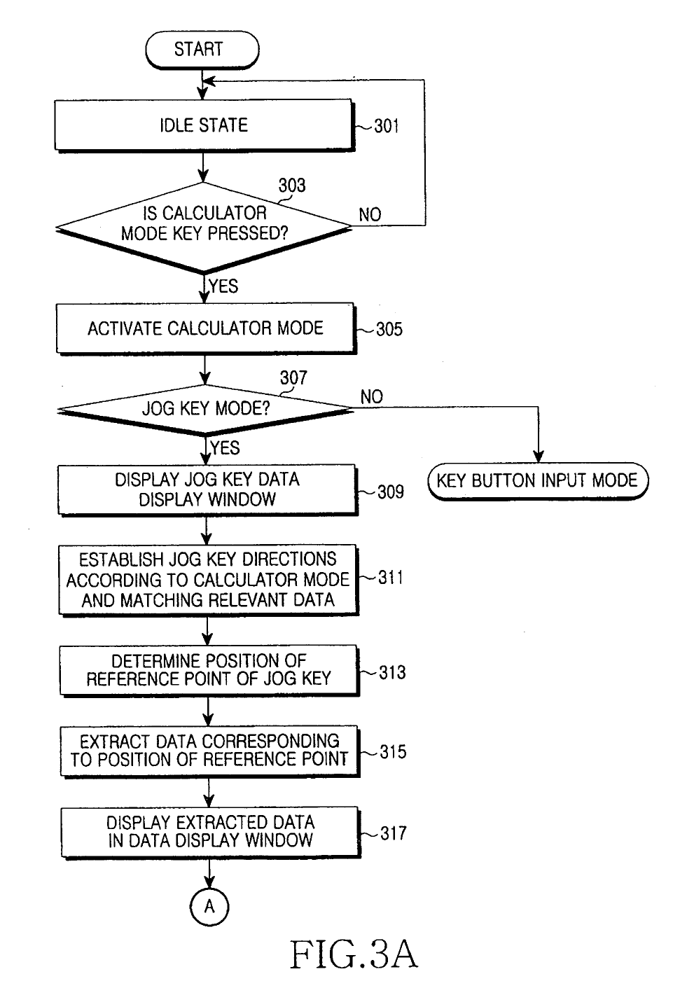

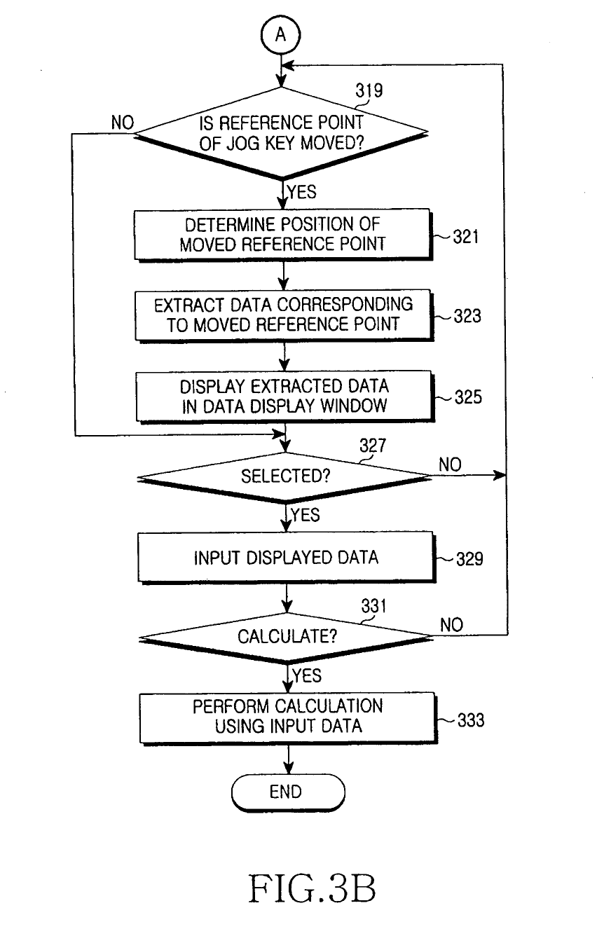

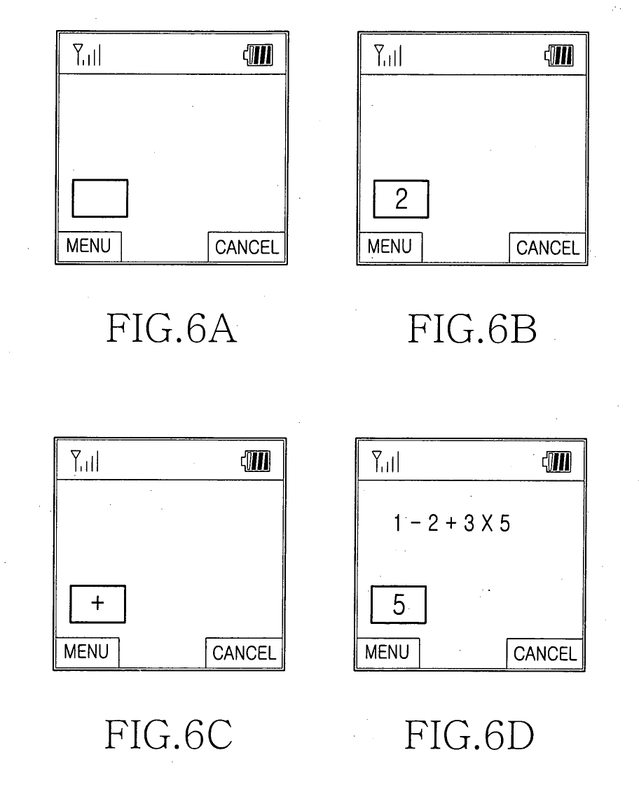

FIGS. 3A and 3B are flowcharts illustrating a method of inputting data by using the jog key 90 in the calculator mode, according to an exemplary embodiment of the present invention, and FIGS. 6A through 6D illustrate the data input according to the method of FIGS. 3A and 3B.

An operation of inputting data by using the jog key 90 in the calculator mode will now be described with reference to FIGS. 3A and 3B and FIGS. 6A through 6D. In an idle mode of step 301, the controller 216 determines in step 303 whether the user presses a calculator mode key. If the user presses the calculator mode key, in step 305, the controller 216 activates the calculator mode by controlling the memory 29. In step 307, the controller 216 determines whether a current mode of the wireless terminal is the jog key using mode. If the current mode is the jog key using mode as the determination result, in step 309, the controller 216 controls the memory 29 and the display unit 80 to display the data display window as illustrated in FIG. 6A. Even if the folder is folded and the keypad 27 is not seen, the jog key using mode can be activated by using the side key, such as hot key.

In step 311, the controller 216 establishes jog key directions according to the calculator mode by controlling the memory 29 and the jog key 90. For example, if the current mode of the wireless terminal is the calculator mode, a plurality of pairs of N poles and S poles are divided into 12 directions matching ‘0-9,’ ‘− (negative number),’ and ‘. (decimal point),’ which are data required in the calculator mode. In addition, by dividing the 12 directions by 4, the controller 216 matches the center (the boundary between the N pole and the S pole) of the up direction with ‘+ (addition),’ the center (the boundary between the N pole and the S pole) of the down direction with ‘− (subtraction),’ the center (the boundary between the N pole and the S pole) of the right direction with ‘* (multiplication),’ and the center (the boundary between the N pole and the S pole) of the left direction with ‘/ (division).’ In another way, the controller 216 may match 4 parts obtained by dividing the 12 directions by 4 with the operators (+, −, *, and /). That is, the controller 216 may match the first to third directions with ‘+,’ the fourth to sixth directions with ‘−,’ the seventh to ninth directions with ‘*,’ and the tenth to twelfth directions with ‘/’. In this case, each of the operators (+, −, *, and /) can be input by locating the reference point of the jog key 90 at a desired position and pressing the jog key 90 for a long time or the side key (shift) once.

In step 313, the controller 216 determines a position of the reference point of the jog key 90 by controlling the memory 29 and the jog key 90. In step 315, the controller 216 extracts data corresponding to the position of the reference point. In step 317, the controller 216 controls the display unit 80 to display the extracted data in the data display window as illustrated in FIG. 6B. For example, when the jog key 90 are established to 12 directions according to the calculator mode, if the reference point of the jog key 90 is located at the third direction, ‘2’ is displayed in the data display window, and if the reference point of the jog key 90 is located at the center (the boundary between the N pole and the S pole) of the up direction obtained by dividing the 12 directions by 4, ‘+’ is displayed in the data display window as illustrated in FIG. 6C.

When the user moves the reference point of the jog key 90 in the left or right direction to input desired data, the jog key 90 outputs a jog key reference point position signal generated by the left or right rotation to the controller 216. In step 319, the controller 216 determines whether the jog key reference point position signal is input. If the jog key reference point position signal is input, the controller 216 determines a position of the moved reference point in step 321, extracts data corresponding to the position of the reference point in step 323, and controls the display unit 80 to display the extracted data in the data display window in step 325.

In step 327, the controller 216 determines whether the user presses a ‘selection’ key to input the data displayed in the data display window. If the ‘selection’ key is pressed, in step 329, the controller 216 inputs the data displayed in the data display window by controlling the memory 29 and the display unit 80 and displays the input data as illustrated in FIG. 6D. The data input can be achieved by pressing the jog key 90 or using the side key.

In step 331, the controller determines whether a ‘calculation (operation)’ key is pressed. If the ‘calculation’ key is pressed, in step 333, the controller 216 calculates the input data by controlling the memory 29. The ‘calculation’ key can be replaced by pressing the jog key 90 steadily or using the side key.

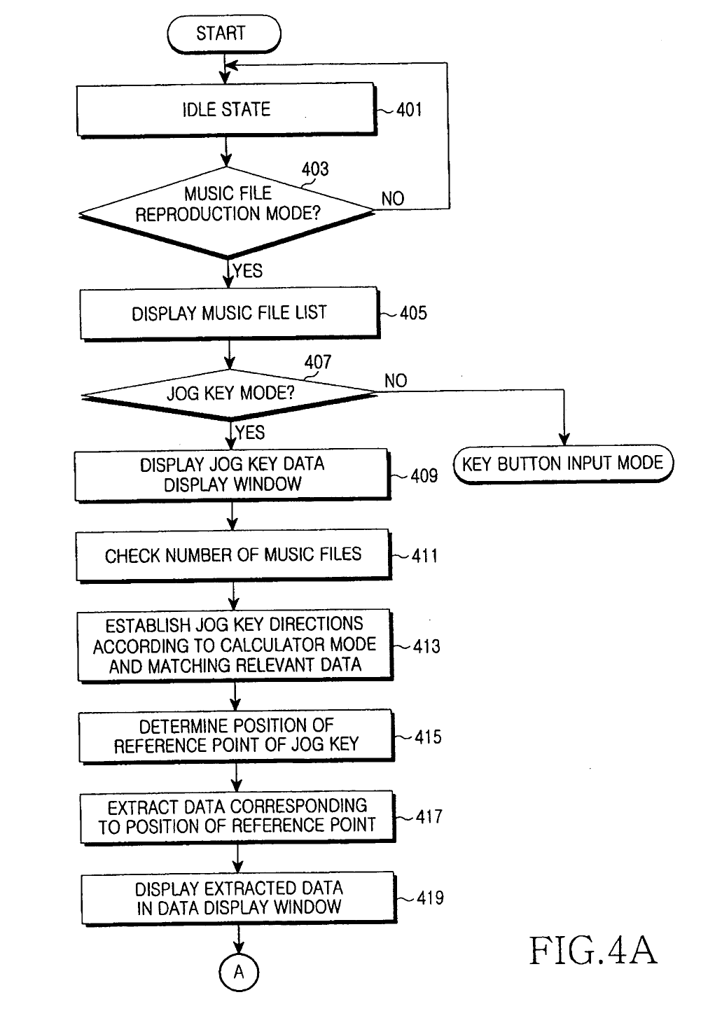

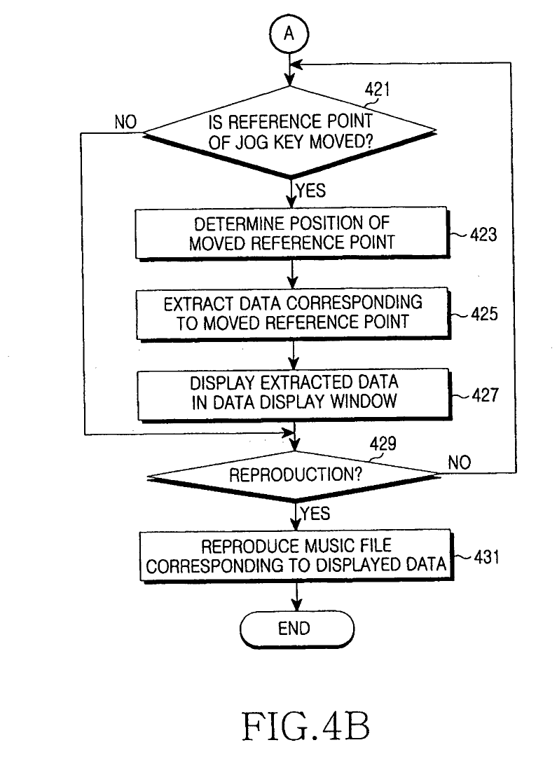

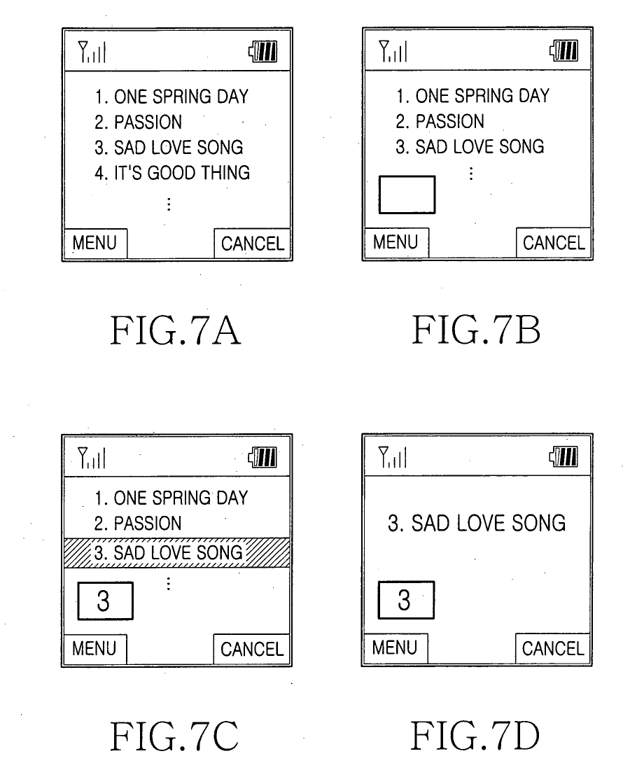

FIGS. 4A and 4B are flowcharts illustrating a method of inputting data by using the jog key 90 in the music file reproduction mode according to an exemplary embodiment of the present invention, and FIGS. 7A through 7D illustrate the data input according to the method of FIGS. 4A and 4B.

An operation of inputting data by using the jog key 90 in the music file reproduction mode will now be described with reference to FIGS. 4A and 4B and FIGS. 7A through 7D. In an idle mode of step 401, the controller 216 determines in step 403 whether the user presses a music file reproduction mode key. If the user presses the music file reproduction mode key, in step 405, the controller 216 displays a music file list as illustrated in FIG. 7A by controlling the memory 29 and the display unit 80. In step 407, the controller 216 determines whether a current mode of the wireless terminal is the jog key using mode. If the current mode is the jog key using mode as the determination result, in step 409, the controller 216 controls the memory 29 and the display unit 80 to display the data display window as illustrated in FIG. 7B. Even if the folder is folded and the keypad 27 is not seen, the jog key using mode can be activated by using the side key, such as hot key.

In step 411, the controller 216 checks the number of music files, and in step 413, the controller 216 establishes jog key directions according to the number of checked music files by controlling the memory 29 and the jog key 90. For example, if the number of checked music files is fifteen (15), a plurality of pairs of N poles and S poles are divided into fifteen (15) directions matching the music file data, and if the number of checked music files is thirty six (36), the plurality of pairs of N poles and S poles are divided into thirty six (36) directions matching the music file data. If the number of checked music files is more than thirty six (36), directions of the jog key 90 can be established to fit the number of currently displayed music files.

In step 415, the controller 216 determines a position of the reference point of the jog key 90 by controlling the memory 29 and the jog key 90. In step 417, the controller 216 extracts data corresponding to the position of the reference point. In step 419, the controller 216 controls the display unit 80 to display the extracted data in the data display window and distinctively display a music file corresponding to the extracted data in the displayed music file list. For example, when the jog key 90 are established to thirty six (36) directions according to the number of music files, if the reference point of the jog key 90 is located at the third direction, ‘3’ is displayed in the data display window, and if a music file corresponding to ‘3’ is distinguished from the others in the displayed list as illustrated in FIG. 7C.

When the user moves the reference point of the jog key 90 in the left or right direction to reproduce a desired music file, the jog key 90 outputs a jog key reference point position signal generated by the left or right rotation to the controller 216. In step 421, the controller 216 determines whether the jog key reference point position signal is input. If the jog key reference point position signal is input, the controller 216 determines a position of the moved reference point in step 423, extracts data corresponding to the position of the reference point in step 425, and controls the display unit 80 to display the extracted data in step 427.

In step 429, the controller 216 determines whether the user presses a ‘selection’ key to reproduce the music file corresponding to the data displayed in the data display window. If the ‘selection’ key is pressed, in step 431, the controller 216 reproduces the music file corresponding to the data displayed in the data display window by controlling the memory 29 and the display unit 80 and displays the title of the reproduced music file as illustrated in FIG. 7D. The music file reproduction can be achieved by pressing the jog key 90 or using the side key.

As described above, according to exemplary embodiments of the present invention, by using a jog key instead of numeral keys and keys for performing various functions in a wireless terminal, the size of a keypad can be reduced, thereby extending the size of a display unit. In addition, since a user can use functions more easily and conveniently without a bothersome keypad operation, the convenience of the user can increase.

While the invention has been shown and described with reference to certain exemplary embodiment thereof, it will be understood by those skilled in the art that various changes in form and details may be made therein without departing from the spirit and scope of the invention as defined by the appended claims.

What is claimed is:

1. A method of inputting data in a wireless terminal having a jog key, the method comprising the steps of:
determining whether a current mode is a jog key using mode, and if the current mode is the jog key using mode, displaying a data display window;
determining a position of a reference point of the jog key and displaying data corresponding to the position of the reference point in the data display window; and
inputting the data displayed in the data display window.

2. The method of claim 1, wherein the displaying step comprises the steps of:
determining a current function mode;
establishing jog key directions according to the function mode and data corresponding to the jog key directions; and
detecting a signal of the position of the reference point and extracting data corresponding to the position of the reference point.

3. The method of claim 1, further comprising the steps of:
detecting a signal of a position of the moved jog key reference point if the reference point of the jog key is moved;
extracting data corresponding to the position of the reference point; and
displaying the extracted data in the data display window.

4. The method of claim 1, wherein the data displayed in the data display window is input when a key is pressed.

5. The method of claim 1, wherein the jog key using mode comprises a state where at least one of a folder is folded and a keypad is not seen.

6. The method of claim 4, wherein the key comprises the jog key.

7. A method of inputting data in a wireless terminal having a jog key, the method comprising the steps of:
when a calculator mode key is pressed, activating the calculator mode and determining whether a current mode is a jog key using mode;
if the current mode is the jog key using mode, displaying a data display window;
establishing jog key directions according to the calculator mode and data corresponding to the jog key directions, determining a position of a reference point of the jog key, and displaying data corresponding to the position of the reference point in the data display window; and
inputting the data displayed in the data display window.

8. The method of claim 7, further comprising the steps of:
if the reference point of the jog key is moved, detecting a signal of a position of the moved jog key reference point;
extracting data corresponding to the position of the reference point; and
displaying the extracted data in the data display window.

9. The method of claim 7, wherein, when a key is pressed, the data displayed in the data display window is input.

10. The method of claim 7, wherein the jog key using mode comprises a state where at least one of a folder is folded and a keypad is not seen.

11. The method of claim 9, wherein the key comprises the jog key.

12. A method of inputting data in a wireless terminal having a jog key, the method comprising the steps of:
when a music file reproduction mode key is pressed, displaying a music file list and determining whether a current mode is a jog key using mode;
if the current mode is the jog key using mode, displaying a data display window;
establishing jog key directions according to the music file reproduction mode and data corresponding to the jog key directions, determining a position of a reference point of the jog key, and displaying data corresponding to the position of the reference point in the data display window; and
inputting the data displayed in the data display window.

13. The method of claim 12, wherein the jog key directions are established according to the number of music files.

14. The method of claim 12, further comprising the steps of:
if the reference point of the jog key is moved, detecting a signal of a position of the moved jog key reference point;
extracting data corresponding to the position of the reference point; and
displaying the extracted data in the data display window.

15. The method of claim 12, wherein, when a key is pressed, the data displayed in the data display window is input.

16. The method of claim 15, wherein the key comprises the jog key.

17. A wireless terminal comprising:
a controller;
a display unit; and
a jog key;
wherein if the controller determines that a current mode comprises the jog key usage mode, a data display window is displayed on the display unit,
a position of a reference point of the jog key is determined and data responding to the reference point is displayed on the display windows, and
a data input to a wireless terminal comprises the data displayed in the data display windows.

18. The wireless terminal in claim 17, further comprising at least one of a folder and a keypad, where the jog key usage mode comprises a state where at least one of the folder is folded and the keypad is not seen.
